(19) United States
(12) Patent Application Publication
(10) Pub. No.: US 2026/0299916 A1
(43) Pub. Date: Oct. 1, 2026

(54) RING ORCHESTRATION ENGINE(S) FOR GENERATING DEPLOYMENT RING ASSIGNMENTS BASED ON TARGET ASSET LANDSCAPE

(71) Applicant: Microsoft Technology Licensing, LLC, Redmond, WA (US)

(72) Inventors: Ganit YAHUD, Givat Koah (IL); Shir FELDMAN, Tel Aviv (IL); Dan Yochanan LEVI, Tel Aviv (IL); Shay Chriba SAKAZI, Herzliya (IL); Yoav YASSOUR, Zikhron Yaakov (IL); Tamer SALMAN, Haifa (IL); Benyamin FARSHTEINDIKER, Petah Tiqwa (IL); Saar SCHEINKMAN, Hod HaSharon (IL); Moshe ISRAEL, Redmond, WA (US); Tomer TELLER, Tel Aviv (IL); Ali MUSTAFA, Berlin (DE); Shai YANNAI, Haifa (IL)

(21) Appl. No.: 19/091,141

(22) Filed: Mar. 26, 2025

(51) Int. Cl. G06F 8/65

(52) U.S. Cl. CPC G06F 8/65

(57) ABSTRACT

Systems and methods herein provide a ring orchestration engine and its related functions. In an aspect, a ring orchestration engine determines target assets designated within a scope of deployment of a new code. The ring orchestration engine then determines one or more asset properties for the target assets and classifies the target assets into asset groups based on the one or more asset properties. From the classification, the ring orchestration engine determines an asset landscape for the target assets based on the plurality of asset groups and generates a ring deployment plan based on the asset landscape. Once the ring deployment plan is generated, the ring orchestration engine initiates deployment of the new code according to the ring deployment plan.

### TECHNICAL FIELD

Aspects of the disclosure are related to the field of computer software applications and services and, in particular, to ring orchestration engines for autonomously determining a target asset landscape and generating a deployment ring plan based on the target asset landscape.

### BACKGROUND

In an increasingly digital world, the deployment of new code is used to maintain innovation while ensuring system stability. To achieve this balance, organizations often rely on ring deployment-a progressive release strategy that incrementally rolls out updates to different target asset segments, reducing risk and allowing for real-time monitoring. Target assets are grouped into “rings,” starting with internal testers (e.g., canary or alpha users) before gradually expanding to broader audiences, such as beta users and eventually the general public. This phased approach enables developers to detect and address issues early, implement rollbacks if necessary, and ensure a smooth, controlled release. Widely used in cloud-based applications, Saas (Software as a Service) platforms, and enterprise software, ring deployment strikes a balance between rapid innovation and reliability.

### SUMMARY

Technology disclosed herein includes software applications and services that provide a ring orchestration engine, and its related functions. In an aspect, a ring orchestration engine determines the target assets identified for deployment of a new code, which may include various computing devices, such as client devices or servers. Based on the identified target assets, the ring orchestration engine determines an asset landscape for the target assets. The asset landscape may reflect the composition, distribution, and heterogeneity of the target assets within the asset population designated for the new code deployment. Using the asset landscape, the ring orchestration engine then generates a ring deployment plan, where the ring deployment plan contains multiple deployment rings for incrementally deploying the new code and the target assets are assigned a given deployment ring according to the asset landscape.

Responsive to generating the ring deployment plan, the ring orchestration engine may initiate deployment of the new code. For example, the ring orchestration engine may be in operable communication with a deployment system and may transmit ring information for a first deployment ring to the deployment system. The ring information may include asset information of the target assets assigned to the first deployment ring. The deployment system may then deploy the new code according to the ring information (and/or ring deployment plan). Responsive to the results from deployment of the first deployment ring, the ring orchestration engine may revise or update the ring deployment plan.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a ring orchestration engine, according to an embodiment herein;

FIG. 2 illustrates an example environment in which a ring orchestration engine is leveraged for automatic generation of ring deployment plans based on an asset landscape, according to an embodiment herein;

FIG. 3 illustrates a process for providing a ring orchestration engine and its related functions, according to an embodiment herein;

FIG. 4 illustrates classification of target assets into asset groups, according to an embodiment herein;

FIG. 5 illustrates an example prompt providing recommendations, according to an embodiment herein;

FIG. 6 illustrates an example prompt providing a summary of a ring deployment plan revised per the recommendations of FIG. 5, according to an embodiment herein;

FIG. 7 illustrates an example operational flow for automatically generating a ring deployment plan for deployment of a new code, according to an embodiment herein; and

FIG. 8 shows an example client device suitable for providing a ring orchestration engine and related functions, according to an embodiment herein.

### DETAILED DESCRIPTION

One concern when deploying new code in production is ensuring that the release is free of bugs and does not introduce downtime or degrade system performance. This concern is amplified in environments supporting business customers, where deployment failures can disrupt essential applications and workflows. To mitigate these risks, organizations commonly implement ring deployment, a staged rollout strategy that incrementally introduces updates to predefined groups of target assets (e.g., client devices, servers, computing resources). By deploying changes to smaller, controlled groups-such as internal testers or early adopters-before reaching broader audiences, potential issues can be identified and addressed early in the process. This approach localizes the impact of defects, ensuring that any disruptions are contained within the current deployment ring before the update progresses to the next stage.

However, in some scenarios, not all target assets within a system are identical, and deployment to an early ring does not always guarantee a smooth rollout in subsequent rings due to the diversity of deployed environments. Target assets, including client devices, servers, and other infrastructure, may differ in hardware configurations, operating system versions, dependencies, and application workloads, which can introduce unforeseen compatibility issues as deployment expands. For example, if a new software update is initially tested on client devices running one version of an operating system, its success in that environment does not necessarily indicate it will function correctly on client devices running a different version. Differences in system libraries, security policies, and background processes can lead to unexpected failures in later rings.

Conventional ring deployment approaches typically rely on randomly sampling the entire asset population to determine which asset groups receive updates at each stage. This method assumes that issues identified in earlier deployment rings will be indicative of failures in later rings, allowing developers to mitigate risks before broader deployment. However, traditional sampling techniques do not account for the diversity of the asset landscape, including variations in hardware configurations, operating system versions, application workloads, and device types. As a result, early rings may not accurately represent the conditions of subsequent rings, leading to unforeseen compatibility issues as deployment progresses. Without a structured approach to incorporating a representative sample of the broader ecosystem, conventional ring deployment methods may fail to detect environment-specific failures, increasing the risk of disruptions in later stages.

Failing to account for asset diversity in ring deployment can lead to several negative outcomes. Compatibility issues may go unnoticed in early rings and only surface when the update is deployed to a broader audience, potentially causing widespread disruptions. For instance, software that functions well in initial deployment rings may encounter failures on systems with different hardware architectures, operating system versions, or conflicting third-party applications, resulting in crashes, degraded performance, or security vulnerabilities. Additionally, the inability to detect environment-specific failures early increases the likelihood of costly rollbacks, emergency patches, and customer dissatisfaction. In enterprise and mission-oriented environments, these failures can lead to operational downtime, revenue loss, and reputational damage. Ultimately, the lack of a targeted approach to ring composition undermines the effectiveness of phased rollouts, reducing the overall reliability and stability of the deployment process.

To address at least the above shortcomings of conventional ring deployment approaches, a ring orchestration engine is provided herein. In particular, a ring orchestration engine is provided herein for autonomously generating a ring deployment plan tailored to the target asset landscape. As will be described in greater detail below, responsive to detecting a request for deployment of new code to an asset population, the ring orchestration engine identifies the target assets within the asset population. For the target assets, the ring orchestration engine determines an asset landscape. The asset landscape encompasses the diversity and distribution of various asset properties within the asset population. That is, the asset landscape includes the number of target assets that share one or more common asset properties, such as hardware configurations, operating system versions or platforms, application workloads, exposure scores, and device categories.

Based on the asset landscape, the ring orchestration engine generates a ring deployment plan for deploying the new code. To generate the ring deployment plan, the ring orchestration engine may determine a number of rings for the ring deployment plan, such as determine a pre-defined number of rings as set by a deployment team. Additionally, the ring orchestration engine may determine a diversity of coverage for deployment of the new code. The diversity of coverage may ensure that the defined deployment rings include a representative mix of target assets having respective asset properties, such as different hardware configurations, operating system versions, application workloads, and device categories. Based on the number of deployment rings and the asset landscape, the ring orchestration engine computes a minimum number of target assets containing a shared asset property for a deployment ring, while satisfying the diversity of coverage.

By generating deployment rings that accurately reflect the diversity of the asset population, the ring orchestration engine provides several technical advantages over conventional approaches. For example, by ensuring that a deployment ring includes a combination of asset properties that represent the asset population, the ring orchestration engine improves the likelihood of identifying compatibility issues early in the deployment process. This targeted approach reduces the risk of unforeseen failures in later rings, minimizing disruptions and costly rollbacks. Additionally, the ring orchestration engine enhances test coverage by exposing new code to a broad range of real-world conditions, leading to more robust and resilient software releases. In enterprise and mission-oriented environments, the ability to deploy new code to early deployment rings that reflect the real-world asset population helps maintain service continuity, improve customer satisfaction, and optimize operational efficiency by preventing downtime and performance degradation before updates reach full-scale deployment.

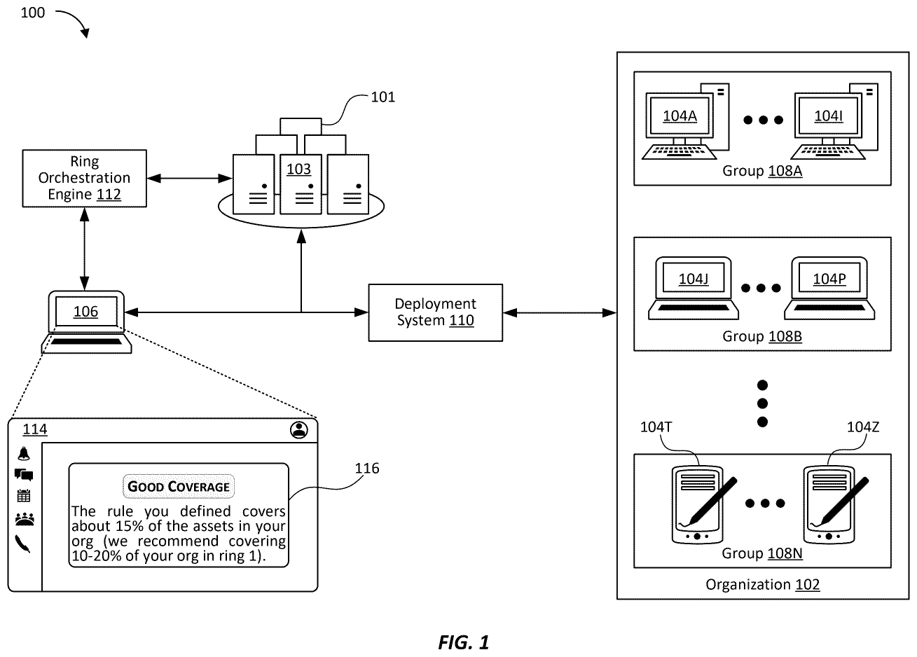

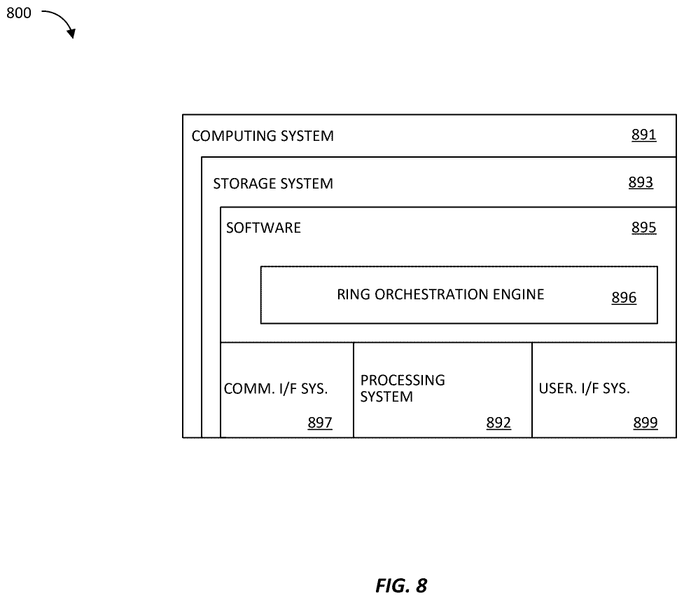

Turning now to the Figures, FIG. 1 illustrates an operational environment 100 for providing a ring orchestration engine 112, according to an embodiment herein. As illustrated, the operational environment 100 includes an organization 102 that comprises multiple client devices 104A-Z. The client devices 104A-Z encompass a broad range of computing and communication devices, including but not limited to personal computers, tablet computers, mobile phones, gaming consoles, wearable devices, Internet of Things (IoT) devices, and other network-enabled devices. While the following embodiments primarily discuss client devices 104A-Z, other categories of devices are also contemplated, such as servers, edge computing devices, network appliances, databases, storage systems, embedded systems, containers, and orchestrated workflows. FIG. 8 depicts system 800, which serves as a generalized representation of client devices 104A-Z, as well as other device types referenced herein, which may feature diverse hardware and software configurations optimized for various use cases.

The client devices 104A-Z execute and operate software that enables various functionalities, including computing tasks, communication, data processing, and user interactions. The software running on the client devices 104A-Z may include operating systems, applications, middleware, firmware, and other system components. Over time, software updates, patches, and new versions may be released to improve performance, introduce new features, enhance security, or address compatibility issues. These updates can be deployed through automated or manual processes, depending on client devices' 104A-Z capabilities, network infrastructure, and organizational policies.

A client device 106, which may be associated with a DevOps team within the organization 102, may be used to develop and deploy new code to the client devices 104A-Z. A user of the client device 106 may manage the continuous integration and continuous deployment (CI/CD) pipeline for software updates to the client devices 104A-Z, including developing, testing, and packaging new code. As used herein, “new code” may encompass software modifications, enhancements, patches, bug fixes, feature additions, configuration updates, or any other programmatic changes intended to improve functionality, performance, security, or compatibility of the software running on the client devices 104A-Z. The client device 106—of which system 800 in FIG. 8 is broadly representative—may facilitate validation processes to ensure that the new code meets functional and security requirements before deployment.

Once the new code is validated, the client device 106 may implement a ring deployment plan to gradually rollout the new code to the client devices 104A-Z. To execute the deployment plan, the client device 106 may be in operational communication with an application service/platform 101. The application service/platform 101 is a central computing system that provides various software-based functionalities to the client devices 104A-Z within the organization 102. Depending on its design and purpose, the application service/platform 101 may operate as either a service or a platform. As a service, it may provide specific functionalities such as authentication, data storage, content delivery, or computational processing that client devices 104A-Z and client device 106 can access remotely. As a platform, it may offer a broader set of tools, frameworks, and infrastructure that support the development, deployment, and management of applications used by the organization. The choice between a service and a platform depends on the operational needs of the organization-if it primarily supports lightweight, modular services, it may function as a service, whereas if it provides an integrated environment for application development and execution, it may function as a platform.

The application service/platform 101 is hosted on computer servers 103, which provide the necessary computational resources, storage, and networking capabilities to support its operation. These computing servers 103 may be physical machines, virtualized instances, or cloud-based infrastructures distributed across data centers. The computer servers 103, of which system 800 in FIG. 8 is broadly representative, handle core processing tasks, maintain data consistency, enforce security policies, and manage incoming and outgoing communication between the various devices connected to the system. Additionally, they may implement load balancing, redundancy, and failover mechanisms to ensure high availability and reliability.

The application service/platform 101 is in operable communication with both the client device 106 and the client devices 104A-Z. The client device 106, which may be utilized by a DevOps team, interacts with the application service/platform 101 to develop, test, and deploy new software or updates. This interaction may involve Application Programming Interface (API) calls, secure shell (SSH) access, or web-based management interfaces that allow administrators to configure and monitor services running on the platform. Meanwhile, the client devices 104A-Z interact with the application service/platform 101 to access hosted applications, retrieve and store data, receive updates, and perform other operational tasks. The communication between these entities may occur over a local network, a virtual private network (VPN), or the internet, utilizing protocols such as HTTP/HTTPS, WebSockets, or message queues to facilitate real-time data exchange and service access.

To deploy the new code, which may be a software update for the client devices 104A-Z, the DevOps team, using client device 106, may coordinate with a deployment system 110. The deployment system 110 is in operable communication with both the client devices 104A-Z and/or the application service/platform 101, enabling it to execute the deployment according to the defined deployment plan. The deployment system 110 may be responsible for managing and automating the distribution of new code to client devices 104A-Z. As such, the deployment system 110 may include deployment orchestration tools, version control systems, rollout management components, and monitoring mechanisms to ensure smooth and controlled software updates. The deployment system 110 may be configured to perform staged rollouts, rollback mechanisms, and verification processes to minimize risks associated with new deployments.

Although illustrated separately for clarity, the deployment system 110 may be an integrated component of either the application service/platform 101 or the broader organization 102. When part of the application service/platform 101, the deployment system 110 may function as a cloud-based or on-premises service responsible for delivering software updates across the distributed client devices 104A-Z. Alternatively, if it is part of the organization 102, it may operate as an internally managed system that aligns with the organization's DevOps processes and infrastructure. Regardless of its implementation, the deployment system 110 ensures efficient and reliable software distribution across the operational environment.

Under conventional approaches, a subset of the client devices 104A-Z is selected for a given ring within a ring deployment plan. This selection process is typically random. That is, conventionally a predefined percentage or number of the client devices 104A-Z is chosen at random for the deployment ring, progressing from a small initial group to increasingly larger groups until full deployment is achieved. This approach is intended to gradually introduce updates while minimizing potential disruptions.

However, random selection may be undesirable because the chosen subset of the client devices 104A-Z is unlikely to accurately reflect the diversity of the asset population within the client devices 104A-Z. The client devices 104A-Z may include a wide range of asset properties, such as varying hardware configurations, operating system versions, network environments, geographical locations, and usage patterns. A purely random selection method does not account for these variations, which can lead to an unrepresentative sample in early deployment rings.

For instance, if a randomly selected subset happens to contain a disproportionately high number of similar devices-such as those with the same operating system version, hardware model, or network conditions-then the early test results may not reveal potential compatibility or performance issues that could arise in other device configurations. This lack of diversity in the asset population increases the risk that undetected software bugs or inefficiencies will manifest only in later rings or during full-scale deployment, potentially leading to widespread issues.

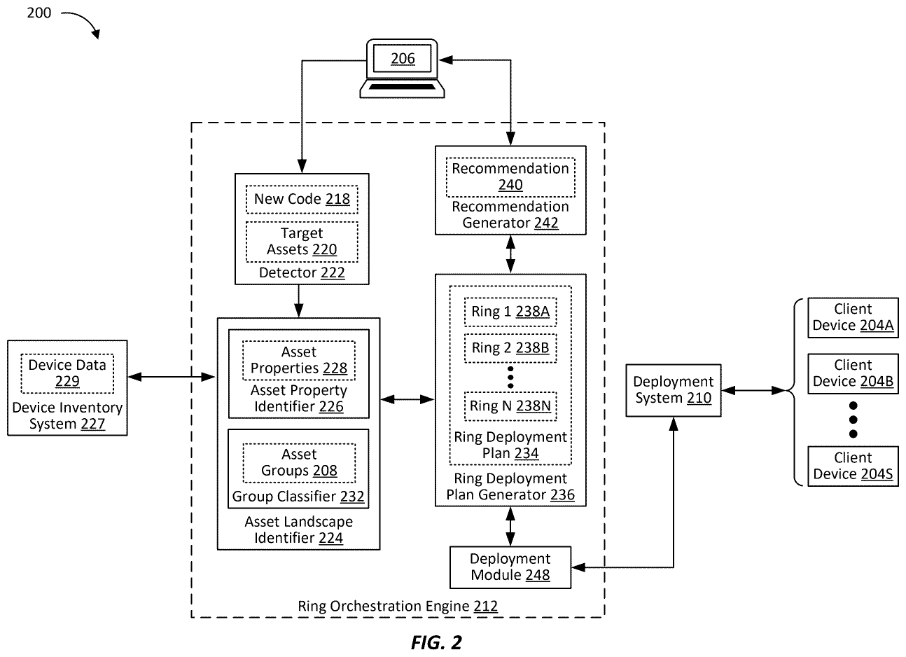

To ensure that the client devices 104A-Z selected for the deployment rings of the deployment plan accurately represent the asset population, the client device 106 may leverage a ring orchestration engine 112. The ring orchestration engine 112 may be in operable communication with the client device 106 and/or the application service/platform 101 to generate a deployment plan for new code deployment. When the ring orchestration engine 112 detects a request to deploy new code, the ring orchestration engine 112 identifies the asset population, which here includes the client devices 104A-Z, and determines the asset properties of the client devices 104A-Z. Based on the asset properties, the ring orchestration engine 112 classifies the client devices 104A-Z into groups 108A-N. Each of these steps are described in greater detail below with respect to FIGS. 2-7.

Once the client devices 104A-Z are classified into the groups 108A-N, the ring orchestration engine 112 generates a ring deployment plan for deployment of the new code. As described in greater detail below, the ring deployment plan may be based, in part, on ring deployment plan parameters such as number of rings, an inclusion constraint, and diversity of coverage that is predefined by the client device 106 (or a DevOps team). In particular, the ring orchestration engine 112 computes a minimum number of client devices 104A-Z from a given group 108A-N to include in a deployment ring while satisfying the diversity of coverage for the asset population. For example, the ring orchestration engine 112 may determine that a first deployment ring includes 5-10% of the client devices 104A-Z in a manner that ensures that 80% of the asset property combinations are covered. Based on this, the ring orchestration engine 112 selects a first subset of the client devices 104A-I from the group 108A, a second subset of the client devices 104J-P from group 108B, and a third subset of the client devices 104T-Z from the group 108N for the first deployment ring.

By ensuring that the deployment rings reflect the diversity of asset properties within the asset population, the ring orchestration engine 112 increases the probability of detecting compatibility issues at an early stage in the deployment cycle. Early detection mitigates the risk of unexpected failures in subsequent deployment phases, thereby minimizing disruptions and costly rollback procedures. As will be described in greater detail below, if responsive to deployment of a deployment ring an issue is detected, the ring orchestration engine 212 may update or revise the ring deployment plan based on the issue. For example, if the ring orchestration engine 212 determines that the issue only affects the client devices 104A-I, the ring orchestration engine 212 may update the remaining deployment rings to exclude the client devices 104A-I from the subsequent deployment rings. This allows deployment of the new code for the remaining client devices 104J-Z to continue, while the issues present for the client devices 104A-I can be addressed before subsequent deployment.

In addition to the above technical advantage, the ring orchestration engine 212 also enhances testing effectiveness by subjecting new code to a wide spectrum of real-world conditions, resulting in more stable and resilient software releases. In enterprise and mission-oriented settings, deploying updates to early-stage rings that accurately mirror real-world asset populations supports service continuity, enhances user experience, and improves operational efficiency by proactively addressing potential performance issues and downtime before widespread deployment.

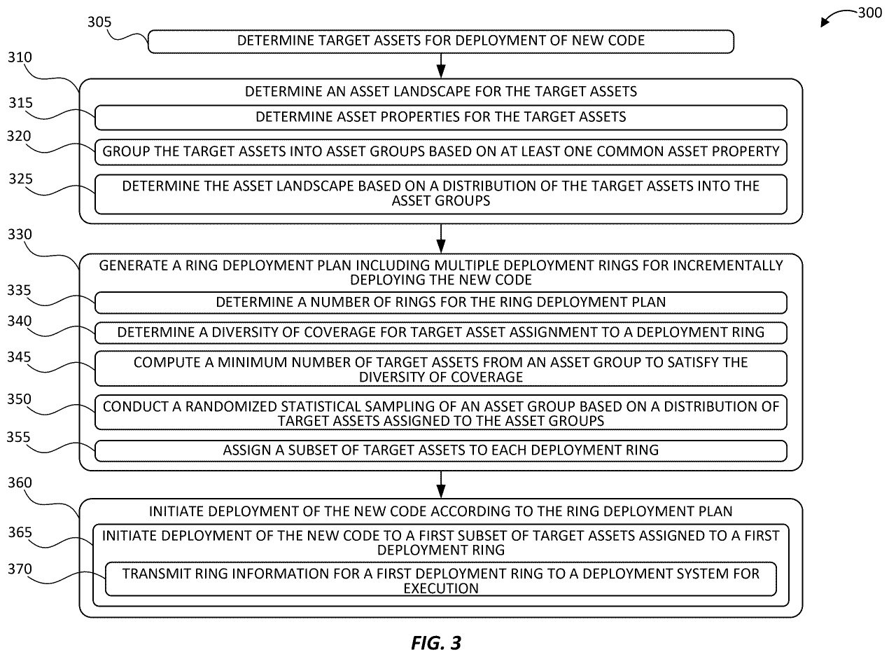

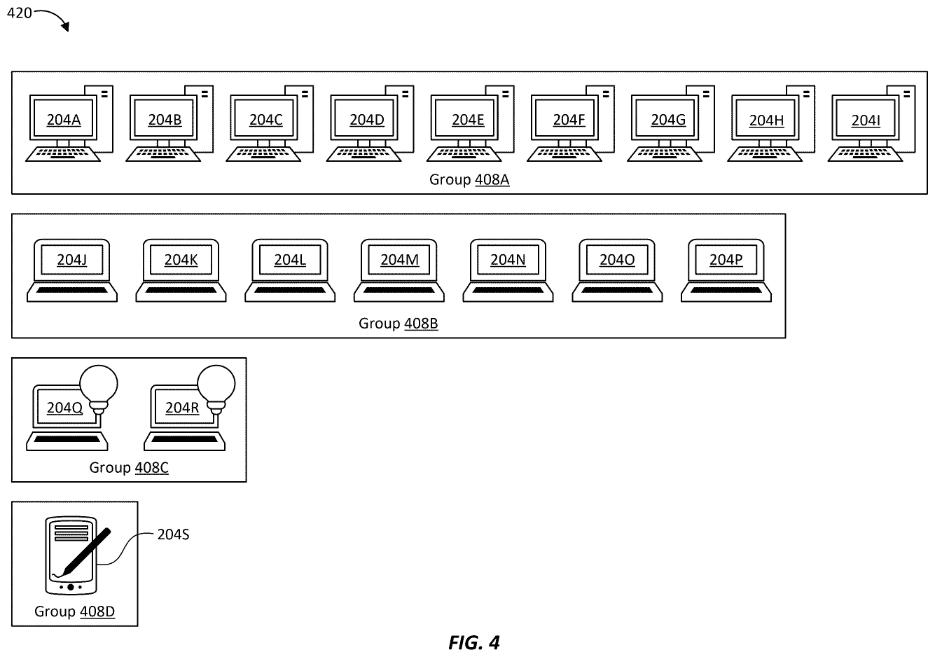

Referring now to FIG. 2, an example environment 200 in which a ring orchestration engine 212 is leveraged for automatic generation of ring deployment plans based on an asset landscape is illustrated, according to an embodiment herein. For ease of explanation, FIG. 2 is described with reference to FIG. 3, which illustrates a process 300 for providing a ring orchestration engine and one or more of its functions, according to an embodiment herein. While FIG. 3 is described in relation to FIG. 2, it should be appreciated that the process 300 is equally applicable to the remaining figures and components therein. FIG. 2 is also described with reference to FIGS. 4-6, each of which is referenced in turn in the following description.

When the ring orchestration engine 212, which may be the same or similar to the ring orchestration engine 112, detects a request to deploy new code 218, the ring orchestration engine 212 determines target assets for the new code deployment (305). In some embodiments, the ring orchestration engine 212 may include a detector 222 that identifies the target assets 220 designated for deployment of the new code 218. The detector 222 may identify the client devices 204A-S as the target assets 220 for the requested deployment. In some embodiments, the client devices 204A-S may be identified in the request or otherwise identified by a client device 206 associated with a DevOps team. For instance, the ring orchestration engine 212 may receive a request from the client device 206, which may be the same or similar to the client device 106, to deploy the new code 218.

As noted above, the new code 218 may be a software update, patch, feature enhancement, security fix, or another type of software modification intended for distribution within an asset population. The asset population may be a set of target assets 220 identified for the new code deployment, such as a subset of target assets within an organization or network. In the illustrated example, the target assets 220 forming the asset population include the client devices 204A-S. The client devices 204A-S may be the same or similar to the client devices 104A-Z, and as described above, may be or include other device categories, such as servers, edge computing devices, network appliances, databases, storage systems, embedded systems, containers, and orchestrated workflows.

In some embodiments, a deployment request for the new code 218 may specify one or more asset properties rather than explicitly identifying the target assets. In such instances, the ring orchestration engine 212 may first identify the available computing devices for deployment and then apply filters based on the specified asset properties to determine the target assets 220 (e.g., the client devices 204A-S). For example, the deployment request may identify computing devices running any version of an operating system released within a predefined timeframe (e.g., 2010-2025). In this case, the ring orchestration engine 212 may identify computing devices operating the specified operating system and further refine the selection based on the release date to identify the client devices 204A-S.

Responsive to identifying the target assets 220, the ring orchestration engine 212 determines an asset landscape for the new code deployment (310). To determine the asset landscape, the ring orchestration engine 212 may include an asset landscape identifier 224. The landscape identifier 224 may include an asset property identifier 226 that identifies the asset properties 228 of the target assets 220, here the client devices 204A-S (315).

Asset properties 228 may encompass various characteristics or attributes of the client devices 204A-S, including device category (e.g., server, endpoint), exposure score, operating system (OS) platform, OS build, remote service capabilities, and other relevant factors. The device category identifies a computing device classification of a respective target asset 220 based on its form factor, functionality, and intended user. For example, the device category may indicate whether a client device 204A-S is a desktop, laptop, tablet, smartphone, embedded system, server, network application, an IoT device, etc. The exposure score may represent a risk assessment metric reflecting security vulnerability, network exposure, or susceptibility to threats. The operating system platform may specify the installed operating system and version, including distribution type for Linux-based systems or edition for Windows/macOS-based devices. Remote service capabilities may define a device's support for remote management, diagnostics, maintenance, update mechanisms, or administrative privileges. Additionally, asset properties may include hardware specifications such as processor type, RAM capacity, storage type and size, and GPU capabilities, as well as software configurations, including installed applications, system settings, and security policies.

To determine the asset properties 228 for the target assets 220, the asset property identifier 226 may interact with various data sources, such as a device inventory system 227 that is external to the ring orchestration engine 212. The asset property identifier 226 may retrieve device data 229 corresponding to the target assets 220 from the device inventory system 227. The retrieval process may be performed in a batch manner or in a streaming manner, depending on the configuration. In an example, the asset property identifier 226 may retrieve the following device data 229 for the client devices 204A-S, along with a timestamp, from the device inventory system 227: an entity identifier (e.g., entity id=server 123), property1 (e.g., OS version=2022), property2 (e.g., application=Finance Application).

In some embodiments, upon retrieving the device data 229, the asset property identifier 226 may preprocess the data to construct an asset property array. This array may be structured as a multi-dimensional dataset, where a row corresponds to an individual target asset 220, and a column represents a specific asset property 228. The asset property array may store various data types, including categorical values (e.g., device category, operating system type), numerical metrics (e.g., exposure scores, available storage, CPU utilization), and Boolean indicators (e.g., remote service capabilities, encryption status), depending on the asset property 228. The preprocessing may involve data normalization, format standardization, and the removal of redundant or incomplete records to ensure consistency and accuracy.

After the ring orchestration engine 212 identifies the asset properties 228 for the target assets 220, the ring orchestration engine 212 classifies the target assets 220 into asset groups 208 (320). In particular, the asset landscape identifier 224 may include a group classifier 232 that classifies the target assets 220 into asset groups 208 based on at least one common asset property 228. That is, the group classifier 232 may parse the asset property array to identify groups of the asset properties 228 based on shared or common asset properties 228.

Reference is now made to FIG. 4 which illustrates asset groups 408A-D identified for the target assets 220, according to an embodiment herein. As illustrated, the group classifier 232 may classify the client devices 204A-S into four asset groups 408A-D. In particular, the group classifier 232 classifies the client devices 204A-S into the asset groups 408A-D based on the asset properties 228 of the respective client device. As indicated by the respective illustrative device, the client devices 204A-S are classified based on at least one common asset property. For example, the client devices 204A-S may be classified according to OS version, with the client devices 204A-I having a first OS version, the client devices 204J-P having a second OS version, the client devices 204Q-R having a third OS version, and the client device 204S having a fourth OS version. As can be appreciated, the number of client devices 204A-S is limited for ease of illustration and in real application the client devices 204A-S may represent hundreds, if not thousands of client devices.

In some embodiments, the group classifier 232 performs clustering of the target assets 220, which in this instance correspond to the client devices 204A-S, based on one or more asset properties 228. In such cases, the group classifier 232 may process the asset property array via a classification algorithm, such as k-means clustering, hierarchical clustering, or density-based spatial clustering, to identify natural groupings of the target assets 220 that share at least one common asset property 228. Once the clustering is complete, the group classifier 232 assigns the target assets 220 to an asset group 208 based on its classification within the identified clusters.

Returning now to FIG. 2, based on the distribution of the client devices 204A-S into the asset groups 408A-D (e.g., 208), the asset landscape identifier 224 determines the asset landscape of the target assets 220 (325). The asset landscape of the target assets 220 characterizes the composition, distribution, and heterogeneity of the target assets 220 within the designated asset population for the new code deployment (e.g., the client devices 204A-S). The asset landscape accounts for variations in the asset properties 228 of the target assets 220 that influence deployment conditions. By defining the structural and functional diversity of the target assets 220, the asset landscape provides a technical representation of the computing environment in which the new code is introduced.

Responsive to determining the asset landscape, the ring orchestration engine 212 generates a ring deployment plan 234 for deploying the new code 218 (330). In particular, the ring orchestration engine 212 may include a ring deployment plan generator 236 that generates the ring deployment plan 234 containing multiple deployment rings 238A-N. To generate the ring deployment plan 234, the ring deployment plan generator 236 may initially determine the ring deployment plan parameters, which may be predefined by an DevOps team and/or the client device 206. For example, the ring deployment plan generator 236 may determine a number of rings for the ring deployment plan 234 (335) and determine a diversity of coverage for the target asset assignment to a deployment ring 238A-N (340). The number of rings for the ring deployment plan 234 defines the number of distinct stages in deployment that the new code 218 is released (e.g., 3 deployment rings 238A-N). The diversity of coverage defines a percentage of target assets 220 that should be represented in the deployment ring 238A-N (e.g., 80%).

Other ring deployment plan parameters may include an inclusion constraint (e.g., a percentage of asset population to be included in a deployment ring), a rollout schedule, such as ring transition timing, promotion criteria, and rollback criteria. Risk management considerations, including canary testing, monitoring and alerting mechanisms, and fail-safe measures, aid in mitigating potential deployment issues. Infrastructure and automation factors, such as CI/CD integration, release orchestration tools, and traffic routing strategies, contribute to the efficiency and reliability of the deployment process. Governance and compliance measures, including approval gates and security checks, ensure that deployments adhere to regulatory and organizational requirements.

Next, the ring deployment plan generator 236 computes the minimum number of target assets 220 from an asset group 208 that should be included in the deployment rings 238A-N to satisfy the required diversity of coverage (345). In the illustrated example, if each of the client devices 204A-S represents 10 client devices, the total asset population is 200 client devices 204A-S, which are categorized into the asset groups 408A-D. The first asset group 408A contains 100 client devices 204A-I, accounting for 50% of the target assets 220. The second asset group 408B consists of 70 client devices 204J-P, representing 35% of the target assets 220. The third asset group 408C includes 20 client devices 204Q-R, making up 10% of the target assets 220. Lastly, the fourth asset group 408D contains 10 client devices 204S, corresponding to 5% of the target assets 220.

Given this distribution, the ring deployment plan generator 236 determines the minimum number of target assets 220 from an asset group 408A-D to include in the deployment rings 238A-N while ensuring that at least 80% of the asset property 228 combinations of the target assets 220 are represented in a given deployment ring 238A-N. In some embodiments, the ring deployment plan generator 236 is also factors in an inclusion constraint that may define the number of selected target assets 220 that should be included in a given deployment ring 238A-N, such as 5-10% of the total asset population.

To determine the minimum number of target assets 220 required from the asset group 408A-D while ensuring that both the diversity of coverage, C, and the inclusion constraint, I_{c}, are satisfied, the ring deployment plan generator 236 employs a linear optimization algorithm. The objective of the linear optimization algorithm is to minimize the total number of target assets 220 included in a given deployment ring 238A-N while satisfying the constraints (e.g., C and I_{c}).

To compute the minimum number of target assets 220 to be selected from the asset groups 408A-D, the ring deployment plan generator 236 may employ the following equation that mathematically expresses the diversity of coverage, C, constraint:

$${\sum }_{j = 1}^{P} {y}_{i} \geq \frac{c}{100} \times P$$

where P represents the total number of unique asset property combinations across the asset population and yⱼ is a binary value indicating whether a given asset property combination, j, is covered in a given deployment ring 238A-N. An asset property combination is considered covered if at least one client device 204A-S associated with that combination of asset properties 228 is selected in a given deployment ring 238A-N. This may be mathematically expressed as:

$${y}_{j} \leq {\sum }_{i ∈ {G}_{j}} {x}_{i} , {∀}_{j}$$

where Gⱼ is the set of asset groups 408A-D containing asset property combination j, and xᵢ represents the number of selected target assets 220 from the asset group i.

Additionally, to maintain diversity of coverage across asset groups 408A-D, the selection from the asset groups 408A-D follows a proportional representation requirement, ensuring that each asset group 408A-D contributes a share based on its size. This requirement is mathematically captured as:

$${x}_{1} \geq {α}_{1} , {x}_{2} \geq {α}_{2} , {x}_{3} \geq {α}_{3} , {x}_{4} \geq {α}_{4}$$

where αᵢ represents the minimum required selection from a given asset group 408A-D, computed based on their respective proportions.

Furthermore, in scenarios where the ring deployment plan generator 236 is constrained by the inclusion constraint, the total number of selected target assets 220 per deployment ring 238A-N is regulated to ensure that it falls within the defined inclusion range. The inclusion constraint is often defined as a range of Pₘᵢₙ % to Pₘₐₓ % of the total asset population. This requirement is expressed as:

$$\frac{{P}_{m i n}}{100} \times T \leq {\sum }_{i = 1}^{N} {x}_{i} \leq \frac{{P}_{m i n}}{100} \times T$$

where T represents the total number of client devices 204A-S in the asset population, and N represents the total number of asset groups 408A-D. This constraint ensures that a given deployment ring 238A-N contains a controlled fraction of the total asset population, thereby satisfying the inclusion constraint. The inclusion constraint balances selection while preventing the over-representation of any single group.

Lastly, a non-negativity constraint ensures that the number of selected target assets 220 remains a non-negative integer:

$${x}_{i} \geq 0 , {x}_{i} ∈ {ℤ}^{+}$$

where [symbol] represents a set of positive integers.

By incorporating the inclusion constraint (Pₘᵢₙ % to Pₘₐₓ % of the total asset population per deployment ring), an upper bound is imposed on the number of selected target assets 220. This may, however, conflict with the diversity of coverage requirement (C % of asset property combinations) if not properly balanced. In cases where meeting the lower bound of diversity of coverage (C %) requires selecting more devices than permitted by the inclusion constraint (Pₘᵢₙ % to Pₘₐₓ % of the total asset population per deployment ring 238A-N), the ring deployment plan generator 236 may adjust the constraints. Possible adjustments include relaxing the diversity of coverage requirement or widening the inclusion constraint range to ensure feasibility. The ring deployment plan generator 236 solves this optimization problem while maintaining compliance with all constraints and ensuring adequate diversity representation.

For the example illustrated in FIG. 4, the ring deployment plan generator 236 may determine a total number of target assets 220 of 200, a diversity of coverage constraint of 80%, an inclusion constraint range of 5-10%, and three deployment rings 238A-N. Based on these constraints and the asset landscape, the ring deployment plan generator 236 may compute the minimum number of client devices 204A-S that should be selected from the asset groups 408A-D for a given deployment ring 238A-N as described in the following paragraph.

For the deployment ring 238A-N, at least three out of the four asset groups 408A-D should be represented to satisfy the 80% diversity of coverage constraint. Additionally, the total number of selected client devices 204A-S should fall within 5-10% of the total asset population (i.e., between 10 and 20 client devices per deployment ring). Given these constraints and the proportional representation of client devices 204A-S across asset groups 408A-D, the ring deployment plan generator 236 determines that the minimum number of client devices 204A-S to be selected per deployment ring 238A-N is: at least one client device 204A-I from the asset group 408A, at least five client devices 204J-P from the asset group 408B, at least two client devices 204A-R from the asset group 408C, and at least two client devices 204S from the asset group 408D. This selection ensures that the required diversity of coverage is met while maintaining adherence to the inclusion constraint.

Responsive to determining the minimum number of target assets 220 to be selected from the asset groups 408A-D for a given deployment ring 238A-N, the ring orchestration engine 212 conducts a randomized statistical sampling of the identified asset groups (350). That is, the ring deployment plan generator 236 selects specific client devices 204A-S for assignment to a given deployment ring 238A-D by performing a randomized statistical sampling within the respective asset group 408A-D. This approach ensures that the selection process remains unbiased, representative of the asset landscape, and aligned with the diversity of coverage and inclusion constraints. Additionally, by leveraging randomized sampling, the ring deployment plan generator 236 avoids over-representation of specific client devices 204A-S while maintaining statistical fairness across the deployment rings 238A-N.

Once the ring deployment plan generator 236 identifies the client devices 204A-S to include at a given deployment ring 238A-N, the ring deployment plan generator 236 assigns the subset of client devices 204A-S to a respective deployment ring 238A-N (355). In some embodiments, to assign a given subset of client devices 204A-S to a deployment ring 238A-N, the ring deployment plan generator 236 generates a listing of asset information corresponding to the subset of client devices 204A-S. For example, for the subset of client devices 204A-S assigned to the first deployment ring 238A, the ring deployment plan generator 236 generates a listing of asset information that contains the asset properties 228 of the subset of client devices 204A-S. In some embodiments, the asset information contains information on the target asset 220 assigned to a given deployment ring 238A-N, such as a name of the target asset, a description, or other information that may be useful during deployment. Example asset information may include details used to identify and track the target assets 220, such as manufacturer, serial number, purchase date, and assigned user. In some cases, the ring information is collected from the device inventory system 227, such as extracted from the device data 229.

The ring deployment plan generator 236 generates the ring deployment plan 234 to include ring deployment information based on the listing of asset information corresponding to the subset of client devices 204A-S assigned to a given deployment ring 238A-N. The ring deployment information may include metadata necessary for orchestrating the staged rollout of the new code 118 (e.g., deploy the new code 118 according to the deployment rings 238A-N), such as asset identifiers, deployment schedules, versioning data, rollback parameters, and dependency mappings. This ring information ensures that the deployment process follows the predefined ring-based deployment strategy, facilitating controlled and incremental distribution of the new code 118 across the client devices 204A-S while minimizing risks associated with software updates.

In some embodiments, once the ring deployment plan 234 is generated, the ring orchestration engine 212 may generate a recommendation 240 including the ring deployment plan 234. In particular, the ring orchestration engine 212 may include a recommendation generator 242 that generates the recommendation 240 responsive to detecting the request to initiate deployment of the new code 218. That is, upon detecting that the client device 206 is initiating deployment of the new code 218, the ring orchestration engine 212 may generate a ring deployment plan 234 and provide it as a recommendation 240 to the client device 206.

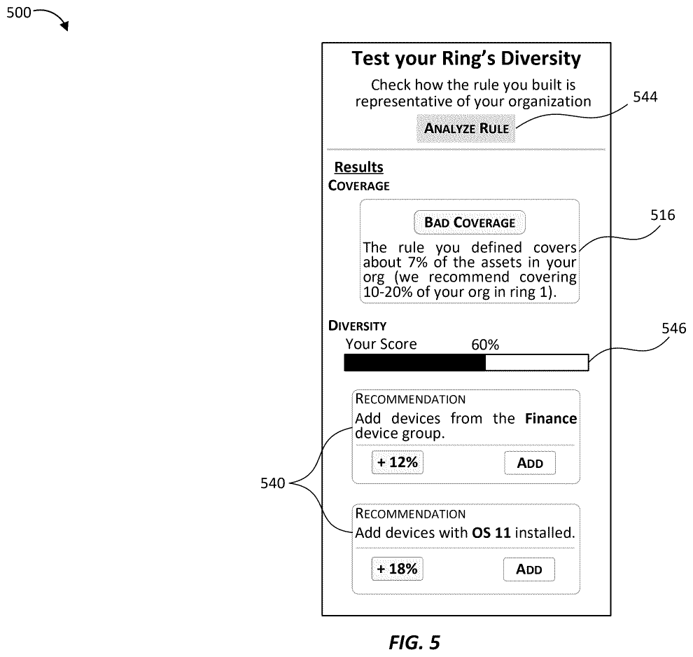

Referring now to FIG. 5, an example prompt 500 providing recommendations 540 is illustrated, according to an embodiment herein. The prompt 500 may be provided to the client device 206, such as via a user interface 114, responsive to the ring orchestration engine 212 detecting a deployment process for the new code 218. As illustrated, the prompt 500 may provide an option 544 for a user of the client device 206 to test an initial rule defined for the deployment process. This may include an initial selection of the client devices 204A-S to be included in the deployment rings 238A-N.

Responsive to selection of the option 544, the ring orchestration engine 212 may analyze the initial selection to determine whether the initial selection provides enough coverage of the asset landscape to accurately reflect the real-world environment. As illustrated, this may include a summary 516 indicating that the initial selection provides minimal coverage, only covering 7% of the target assets 220. The prompt 500 also includes a diversity metric 546 that illustrates that the initial selection of client devices 204A-S only have a 60% diversity of coverage.

Responsive to analyzing the initial selection, the ring orchestration engine 212 generates the recommendations 540 to add additional target assets 220 to one or more deployment rings 238A-N. In the illustrated example, the ring orchestration engine 212 recommends that adding client devices from a Finance device group will increase the diversity of coverage by 12% and adding client devices having an OS version 11 installed will increase the diversity of coverage by 18%. If the user of the client device 206 selects to add these additional client devices, the ring orchestration engine 212 may revise the ring deployment plan 234 according to the additional client devices.

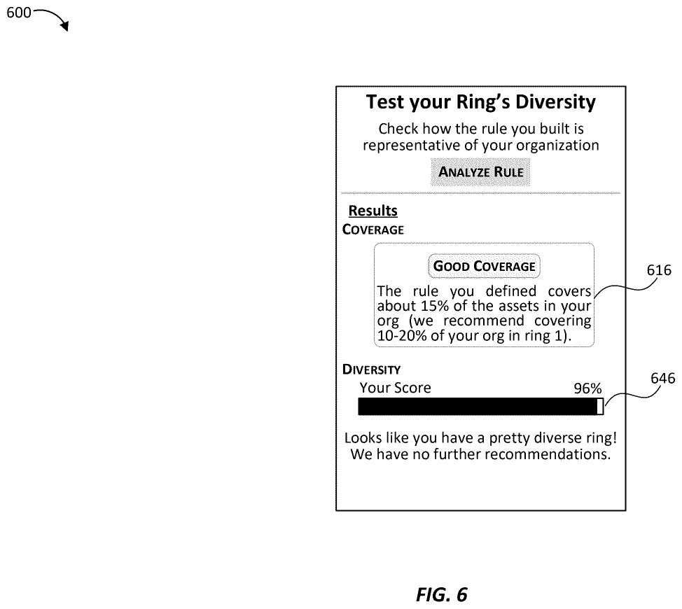

Referring now to FIG. 6, an example prompt 600 providing a summary 516 of the ring deployment plan 234 revised per the recommendations of FIG. 5 is illustrated, according to an embodiment herein. As shown, the summary 616 indicates that as revised, the ring deployment plan 234 now provides a good diversity of coverage. The ring orchestration engine 212 may have revised the ring deployment plan 234 per the recommendations 540 described above with respect to FIG. 5, and as such, added additional target assets 220 from different asset groups 208. Then, based on the revision the ring orchestration engine 212 generates the summary 616 and a diversity metric 646 indicates that the revised ring deployment plan 234 now covers 96% of the asset property combinations present in the asset population. The more asset property combinations the deployment rings cover, the closer the ring deployment plan 234 will reflect the real-time environment of client devices 204A-S.

In some embodiments, instead of analyzing an initial selection of client devices for the deployment rings 238A-N, the client device 206 may prompt the ring orchestration engine 212 to generate the ring deployment plan 234 as part of the deployment process. As such, the ring orchestration engine 212 may perform one or more of the above steps to generate the ring deployment plan 234, and responsively provide the ring deployment plan 234 to the client device 206. By providing the ring deployment plan 234, the user of the client device 206 can evaluate the selection of client devices 204A-S assigned to a deployment ring 238A-N and make any adjustments necessary before initiating deployment, such as adding high-priority client devices to early deployment rings.

Returning now to FIG. 2, once the ring deployment plan 234 is generated, the ring orchestration engine 212 initiates deployment of the new code 218 according to the ring deployment plan (360). This may include initiating deployment of the new code 218 to the first subset of client device 204A-S assigned to the first deployment ring 338A (365). To initiated deployment of the new code 218, ring orchestration engine 212 may include a deployment module 248. The deployment module 248 may be in operational communication with a deployment system 210, which may be the same or similar to the deployment system 110. Once the ring deployment plan 234 is generated and/or approved by the client device 206, the deployment module 248 may transmit the ring information from the ring deployment plan 234 to the deployment system 210 (370). In some cases, the deployment module 248 may transmit the ring information from the ring deployment plan 234 for the first deployment ring 238A, and then the subsequent deployment ring 238B-N after the preceding deployment ring 238A-N is deployed. While in other cases, the deployment module 248 may transmit the ring information or the entire ring deployment plan 234 to the deployment system 210 in a single operation. Responsive to receiving the ring information and/or the ring deployment plan 234, the deployment system 210 may deploy the new code 218 to the client devices 204A-S in accordance with the deployment rings 238A-N.

After the deployment system 210 deploys a deployment ring 238A-N, such as the first deployment ring 238A, the deployment system 210 may evaluate the deployment for potential issues. For example, the deployment system 210 may monitor performance metrics, error logs, and system stability to detect anomalies or failures. If any issues are identified, the deployment system 210 may trigger automated rollback procedures, apply corrective updates, or generate alerts for manual intervention. This evaluation process ensures the integrity of the deployment and minimizes the risk of propagating defects to subsequent deployment rings.

In an example embodiment, the deployment system 210 may detect an issue for a portion of the target assets 220 in the first deployment ring 238A. Rather, the deployment system 210 may detect an issue and return a results to the ring orchestration engine 212. The ring orchestration engine 212 may parse the results and determine that the issue only affects a portion of the target assets 220. The ring orchestration engine 212 may also determine that the affected portion of target assets 220 correspond to the subset of target assets assigned to a particular asset group 208. For example, the subset of client devices 204A-I from the asset group 408A encountered issues during deployment of the first deployment ring 238A. As such, the ring orchestration engine 212 may identify that an issue in the new code 218 affects client devices 204A-I having a specific asset property (e.g., hardware configuration, OS platform or version).

In some embodiments, if the ring orchestration engine 212 determines that a particular portion of the client devices 204A-S classified to a specific asset group 408A-D encounter an issue during deployment, the ring orchestration engine 212 may revise or update the ring deployment plan 234 to remove client devices 204A-S from the specific asset group 408A-D for later deployment rings 238A-N. For example, if the ring orchestration engine 212 determines that the subset of client devices 204A-I from the first asset group 408A encounter issues during deployment of the first deployment ring 238A, the ring orchestration engine 212 may revise the ring deployment plan 234 to remove client devices 204A-I from the subsequent deployment rings 238B-N so that deployment of the new code 218 can continue for the remaining target assets 220 (e.g., client devices 204J-S). This allows the issue to be addressed, while testing of the new code 218 continues. In cases where the first deployment ring 238A completes without any issues, the deployment system 210 may continue with deployment of the subsequent deployment rings 238B-N.

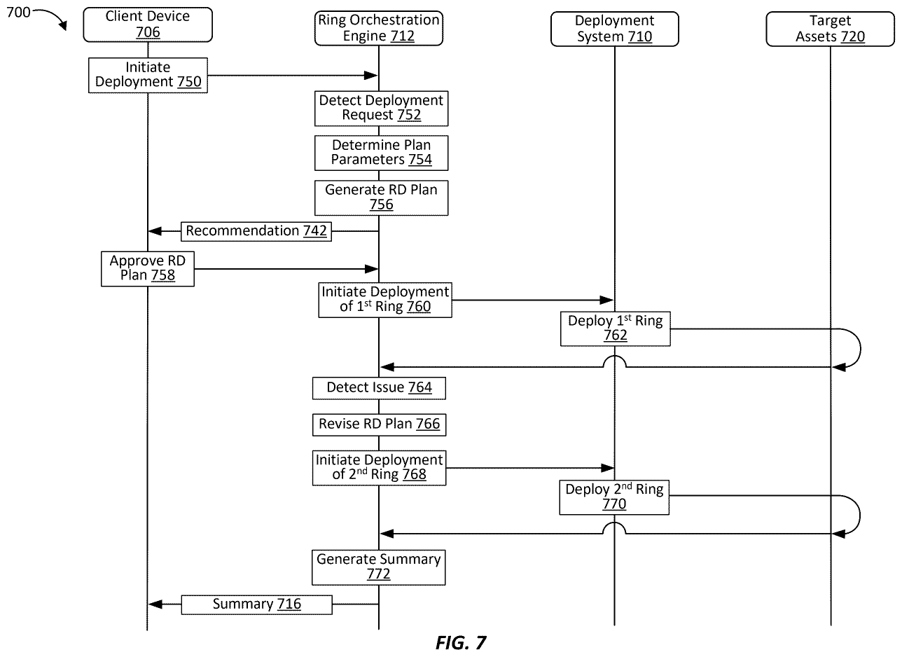

Referring now to FIG. 7, an operational flow 700 for automatically generating a ring deployment plan for deployment of new code is illustrated, according to an embodiment herein. As illustrated, a client device 706, which may be the same or similar to the client device 206, may initiate deployment of a new code (750). A ring orchestration engine 712, which may be the same or similar to the ring orchestration engine 212, may detect the deployment request (752). Responsive to detecting the deployment request, the ring orchestration engine 712 may determine plan parameters for the ring deployment plan (754). As noted above, the client device 706 may predefine or set the plan parameters, such as a diversity of coverage constraint, an inclusion constraint, and a number of rings.

The ring orchestration engine 712 then generates the ring deployment plan as described above (756). For example, the ring orchestration engine 712 determines the target assets identified to be part of the new code deployment and then determines the asset landscape. Based on the asset landscape, the ring orchestration engine 712 assigns the target assets to a particular deployment ring and then generates the ring deployment plan from there. Once the ring deployment plan is generated, the ring orchestration engine 712 then generates a recommendation (740). The recommendation may include the prepared ring deployment plan. The recommendation is transmitted to the client device 706, where a user may then review, modify, and/or approve the ring deployment plan (758).

Responsive to approval of the ring deployment plan, the ring orchestration engine 712 initiates deployment of a first deployment ring (760). As illustrated, this may include transmitting the ring information for the first deployment ring to a deployment system 710, which may be the same or similar to the deployment system 210. When the deployment system 710 receives the ring information, the deployment system 710 deploys the first deployment ring (762). This includes transmitting the new code to the subset of target assets 720, which may be the same or similar to the target assets 220, assigned to the first deployment ring.

In the illustrated example, the ring orchestration engine 712 detects an issue with a portion of the subset of target assets 720 assigned to the first deployment ring (764). Based on the detected issue, the ring orchestration engine 712 revises the ring deployment plan (766), such as removing target assets 720 having common asset properties or assigned to the same asset group as the portion of target assets 720 associated with the issue from subsequent deployment rings.

Once the ring deployment plan is revised, the ring orchestration engine 712 may initiate deployment of the second deployment ring (768). Similar to the first deployment ring, the deployment system 710 receives the ring information for the second deployment ring and responsively deploys the second deployment ring (770). The ring orchestration engine 712 may then continue deploying subsequent deployment rings in sequence, provided no issues are detected, until the ring deployment plan is fully executed. Once the ring deployment plan is complete, the ring orchestration engine 712 generates a deployment summary (772). This summary may include details of the deployment process, such as the sequence of deployments, performance metrics, success rates, and any issues encountered during each stage (e.g., each deployment ring). Additionally, the summary may document any corrective actions taken (e.g., removal of the portion of target assets 720 associated with the issue) and provide insights for future optimizations or improvements to the deployment strategy. The summary is then transmitted to the client device 706 (716).

Referring to FIG. 8, FIG. 8 illustrates a system 800 including a computing apparatus 891 that may be used for providing or interacting with a ring orchestration engine and related functions, as described herein. For example, the client devices 104A-Z, 106, 204A-Z, or 206 may be or include the computing apparatus 891, while in another example, any other device that is part of a deployment ring may be or include the computer apparatus 891. As illustrated, the computing apparatus 891 includes a processing system 892 that includes a microprocessor and other circuitry that retrieves and executes software 895 from storage system 893. The processing system 892 may be implemented within a single processing device but may also be distributed across multiple processing devices or sub-systems that cooperate in executing program instructions. Examples of the processing system 892 include general purpose central processing units, graphical processing units, application specific processors, and logic devices, as well as any other type of processing device, combinations, or variations thereof.

The storage system 893 may comprise any computer-readable storage media or medium readable by processing system 892 and capable of storing software 895. The storage system 893 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 893 may also include computer readable communication media over which at least some of the software 895 may be communicated internally or externally. The storage system 893 may be implemented as a single storage device but may also be implemented across multiple storage devices or sub-systems co-located or distributed relative to each other. The storage system 893 may comprise additional elements, such as a controller capable of communicating with the processing system 892 or possibly other systems.

The software 895 (including ring orchestration engine process 896) may be implemented in program instructions and among other functions may, when executed by the processing system 892, direct the processing system 892 to operate as described with respect to the various operational scenarios, sequences, and processes illustrated herein. For example, the software 895 may include program instructions for implementing a ring orchestration engine and related functions, such as the process 300 or the operational flow 700, as described herein. In some cases, the software 895 may cause one or more features of the ring orchestration engine process 896 to provide or display respective components to a user via a user interface system 899 inoperable communication with a client device, such as the notification 240 to the client device 206.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 895 may include additional processes, programs, or components, such as operating system software, virtualization software, or other application software. The software 895 may also comprise firmware or some other form of machine-readable processing instructions executable by the processing system 892.

In general, the software 895 may, when loaded into the processing system 892 and executed, transform a suitable apparatus, system, or device (of which computing apparatus 891 is representative) overall from a general-purpose computing system into a special-purpose computing system customized to generate features, functionality, and user experiences provided by the ring orchestration engine. Indeed, encoding the software 895 on the storage system 893 may transform the physical structure of the storage system 893. The specific transformation of the physical structure may depend on various factors in different implementations of this description. Examples of such factors may include, but are not limited to, the technology used to implement the storage media of the storage system 893 and whether the computer-storage media are characterized as primary or secondary storage, as well as other factors.

For example, if the computer readable storage media are implemented as semiconductor-based memory, the software 895 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 897 may include communication connections and devices that allow for communication with other computing systems (not shown) over communication networks (not shown). Examples of connections and devices that together allow for inter-system communication may include network interface cards, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 891 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA), graphics processing units (GPUs), or neural processing units (NPUs) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), FPGAs, GPUs, NPUS, and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of which may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a ring orchestration engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### Examples

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage media; a ring orchestration engine comprising processor-executable instructions stored on the computer-readable storage media; and a processor coupled to the computer-readable storage media and configured to execute the processor-executable instructions, wherein the processor-executable instructions, when executed by the processor, direct the computing apparatus, to at least: receive a request for deployment of a new code; determine a plurality of target assets; determine an asset landscape for the plurality of target assets; generate a ring deployment plan based on the asset landscape, wherein: the ring deployment plan comprises a plurality of deployment rings for incrementally deploying the new code; and the plurality of target assets are assigned to a deployment ring of the plurality of deployment rings according to the asset landscape; and initiate deployment of the new code to a first subset of the target assets assigned to a first deployment ring of the plurality of deployment rings.

Example 2 is the computing apparatus of any previous or subsequent Example, wherein the processor-executable instructions to determine the asset landscape of the plurality of target assets, when executed by the processor, further direct the computing apparatus to: determine a plurality of asset properties for the plurality of target assets; group the plurality of target assets into a plurality of asset groups, wherein the target assets in an asset group share at least one common asset property; and determine the asset landscape based on a distribution of the plurality of target assets into the plurality of asset groups.

Example 3 is the computing apparatus of any previous or subsequent Example, wherein: the processor-executable instructions to determine the asset landscape of the plurality of target assets, when executed by the processor, further direct the computing apparatus to: group the plurality of target assets into a plurality of asset groups; and determine the asset landscape based on a distribution of the plurality of target assets into the plurality of asset groups; the processor-executable instructions to generate the ring deployment plan based on the asset landscape, when executed by the processor, further direct the computing apparatus to: determine a number of rings for the ring deployment plan; determine a diversity of coverage for target asset assignment to a deployment ring; and compute a minimum number of target assets from an asset group of the plurality of asset groups for assignment to the first deployment ring, wherein the minimum number of target assets from a respective asset group: satisfies the diversity of coverage; and comprises the first subset of target assets assigned to the first deployment ring.

Example 4 is the computing apparatus of any previous or subsequent Example, wherein: the processor-executable instructions to generate the ring deployment plan based on the asset landscape, when executed by the processor, further direct the computing apparatus to: determine a minimum number of target assets for assignment to a deployment ring of the plurality of deployment rings; generate a listing of target assets assigned to a deployment ring of the plurality of deployment rings; and add asset information to a respective target asset in the listing of target assets; and the processor-executable instructions to initiate deployment of the new code to the first subset of the target assets assigned to the first deployment ring of the plurality of deployment rings, when executed by the processor, further direct the computing apparatus to: transmit the ring deployment plan comprising the listing of target assets to an deployment system for execution.

Example 5 is the computing apparatus of any previous or subsequent Example, wherein the processor-executable instructions, when executed by the processor, further direct the computing apparatus to: detect an issue with the new code responsive to deployment of the first deployment ring; determine that the issue corresponds to a portion of target assets within the first subset of target assets comprising a common asset property; and update the ring deployment plan based on the issue affecting the portion of target assets.

Example 6 is the computing apparatus of any previous or subsequent Example, wherein the processor-executable instructions to determine the asset landscape of the plurality of target assets, when executed by the processor, further direct the computing apparatus to: determine a plurality of asset properties for the plurality of target assets, wherein an asset property comprises at least one of: a device category; an exposure score; an operating system platform; or remote service capabilities; group the plurality of target assets into a plurality of asset groups; and determine the asset landscape based on a distribution of the plurality of target assets into the plurality of asset groups.

Example 7 is a method comprising: determining, by a ring orchestration engine, a plurality of target assets within a scope of new code; determining, by the ring orchestration engine, one or more asset properties for the plurality of target assets; generating, by the ring orchestration engine, the plurality of target assets into a plurality of asset groups based on the one or more asset properties; determining, by the ring orchestration engine, an asset landscape for the plurality of target assets based on the plurality of asset groups; generating, by the ring orchestration engine, a ring deployment plan based on the asset landscape; and initiating deployment, by the ring orchestration engine, of the new code according to the ring deployment plan.

Example 8 is the method of any previous or subsequent Example, wherein: the method further comprises detecting, by the ring orchestration engine, initiation of a deployment process for the new code; and determining, by the ring orchestration engine, the one or more asset properties for the plurality of target assets further comprises: collecting, by the ring orchestration engine, asset information of the plurality of target assets; and identifying, by the ring orchestration engine, the one or more asset properties for the plurality of target assets from the asset information.

Example 9 is the method of any previous or subsequent Example, wherein determining, by the ring orchestration engine, the plurality of target assets within the scope of new code further comprises: analyzing, by the ring orchestration engine, the new code to determine one or more code properties of the new code; determining, by the ring orchestration engine, the scope of the new code based on the one or more code properties; determining, by the ring orchestration engine, a plurality of computing devices available for deployment of the new code; and filtering, by the ring orchestration engine, the plurality of computing devices to identify the plurality of target assets based on the scope of the new code.

Example 10 is the method of any previous or subsequent Example, wherein generating, by the ring orchestration engine, the ring deployment plan based on the asset landscape further comprises: conducting, by the ring orchestration engine, a randomized statistical sampling of an asset group of the plurality of asset groups, wherein the randomized statistical sampling is based on a distribution of the plurality of target assets across the plurality of asset groups; and identifying, by the ring orchestration engine, a first subset of target assets for a first deployment ring based on the randomized statistical sampling of the plurality of asset groups.

Example 11 is the method of any previous or subsequent Example, wherein the ring deployment plan comprises a plurality of deployment rings for incrementally deploying the new code, and the method further comprises: determining, by the ring orchestration engine, a minimum number of target assets for assignment to a deployment ring of the plurality of deployment rings; determining, by the ring orchestration engine, a diversity of coverage for target asset assignment based on the asset landscape; and assigning, by the ring orchestration engine, the plurality of target assets to a deployment ring of the plurality of deployment rings based on the minimum number of target assets and the diversity of coverage.

Example 12 is the method of any previous or subsequent Example, wherein: the method further comprises: generating, by the ring orchestration engine, a recommendation that the new code be deployed according to the ring deployment plan; and causing, by the ring orchestration engine, a client device to display the recommendation; and initiating deployment, by the ring orchestration engine, of the new code according to the ring deployment plan further comprises: receiving, from the client device, an indication to deploy the new code according to the ring deployment plan; and transmitting, by the ring orchestration engine, ring information for at least a first deployment ring of the ring deployment plan to deployment system for execution.

Example 13 is the method of any previous or subsequent Example, wherein generating, by the ring orchestration engine, the ring deployment plan based on the asset landscape further comprises: determining, by the ring orchestration engine, a number of rings for the ring deployment plan; determining, by the ring orchestration engine, a plurality of deployment rings based on the number of rings and the asset landscape, wherein the plurality of deployment rings incrementally deploy the new code to a subset of the plurality of target assets; and assigning, by the ring orchestration engine, at least one target asset from an asset group of the plurality of asset groups to a deployment ring of the plurality of deployment rings based on the asset landscape.

Example 14 is the method of any previous or subsequent Example, wherein the method further comprises: responsive to deployment of the ring deployment plan, detecting, by the ring orchestration engine, an issue with the new code; determining, by the ring orchestration engine, that the issue corresponds to a subgroup of target assets within the first deployment ring comprising a common target property; and updating, by the ring orchestration engine, the ring deployment plan by removing the portion of target assets from at least a second deployment ring based on the issue affecting the portion of target assets.

Example 15 is a computer readable storage media comprising processor-executable instructions configured to cause a processor to: determine, by a ring orchestration engine, a plurality of target assets for deployment of a new code; determine, by the ring orchestration engine, an asset landscape for the plurality of target assets; generate, by the ring orchestration engine, a ring deployment plan based on the asset landscape, wherein: the ring deployment plan comprises a plurality of deployment rings for incrementally deploying the new code; and the plurality of target assets are assigned to a deployment ring of the plurality of deployment rings according to the asset landscape; and transmit, by the ring orchestration engine, ring information for a first deployment ring of the plurality of deployment rings to a deployment system for execution, wherein the deployment system deploys the new code to a first subset of the target assets assigned to the first deployment ring responsive to receiving the ring information.

Example 16 is the computer readable storage media of any previous or subsequent Example, wherein: the processor-executable instructions to determine, by the ring orchestration engine, the asset landscape for the plurality of target assets cause the processor to further execute processor-executable instructions stored in the computer readable storage media to: determine, by the ring orchestration engine, a plurality of asset properties for the plurality of target assets; and group, by the ring orchestration engine, the plurality of target assets into a plurality of asset groups, wherein the target assets in an asset group share at least one common asset property; and the processor-executable instructions to generate, by the ring orchestration engine, the ring deployment plan based on the asset landscape cause the processor to further execute processor-executable instructions stored in the computer readable storage media to: assign, by the ring orchestration engine, at least one target asset from an asset group of the plurality of asset groups to a deployment ring of the plurality of deployment rings based on the asset landscape.

Example 17 is the computer readable storage media of any previous or subsequent Example, wherein the processor-executable instructions cause the processor to further execute processor-executable instructions stored in the computer readable storage media to: responsive to deployment of the first deployment ring, detect, by the ring orchestration engine, an issue with the new code; determine, by the ring orchestration engine, that the issue corresponds to a subgroup of target assets within the first subset of target assets comprising a common target property; and update, by the ring orchestration engine, the ring deployment plan by removing the portion of target assets from at least a second deployment ring based on the issue affecting the portion of target assets.

Example 18 is the computer readable storage media of any previous or subsequent Example, wherein the processor-executable instructions to determine, by the ring orchestration engine, the plurality of target assets cause the processor to further execute processor-executable instructions stored in the computer readable storage media to: analyze, by the ring orchestration engine, the new code to determine one or more code properties of the new code; determining, by the ring orchestration engine, a plurality of computing devices available for deployment of the new code; and filtering, by the ring orchestration engine, the plurality of computing devices to identify the plurality of target assets based on the one or more code properties of the new code.

Example 19 is the computer readable storage media of any previous or subsequent Example, wherein: the processor-executable instructions to determine, by the ring orchestration engine, the asset landscape for the plurality of target assets cause the processor to further execute processor-executable instructions stored in the computer readable storage media to: group, by the ring orchestration engine, the plurality of target assets into a plurality of asset groups, wherein the target assets in an asset group share at least one common asset property; and the processor-executable instructions to generate, by the ring orchestration engine, the ring deployment plan based on the asset landscape cause the processor to further execute processor-executable instructions stored in the computer readable storage media to: conduct, by the ring orchestration engine, a randomized statistical sampling of an asset group of the plurality of asset groups, wherein the randomized statistical sampling is based on a distribution of the plurality of target assets across the plurality of asset groups; and assign, by the ring orchestration engine, at least one target asset from an asset group of the plurality of asset groups to a deployment ring of the plurality of deployment rings based on the randomized statistical sampling of the plurality of asset groups.

Example 20 is the computer readable storage media of any previous or subsequent Example, wherein: the processor-executable instructions cause the processor to further execute processor-executable instructions stored in the computer readable storage media to: generate, by the ring orchestration engine, a recommendation that the new code be deployed according to the ring deployment plan; and cause, by the ring orchestration engine, a client device to display the recommendation; and the processor-executable instructions to transmit, by the ring orchestration engine, the ring information for the first deployment ring of the plurality of deployment rings to the deployment system for execution cause the processor to further execute processor-executable instructions stored in the computer readable storage media to: receive, from the client device, an indication to deploy the new code according to the ring deployment plan; and transmit, by the ring orchestration engine, the ring information for the first deployment ring to deployment system responsive to the indication.

What is claimed is:

1. A computing apparatus comprising:
a computer-readable storage media;
a ring orchestration engine comprising processor-executable instructions stored on the computer-readable storage media; and
a processor coupled to the computer-readable storage media and configured to execute the processor-executable instructions, wherein the processor-executable instructions, when executed by the processor, direct the computing apparatus, to at least:
receive a request for deployment of a new code;
determine a plurality of target assets;
determine an asset landscape for the plurality of target assets;
generate a ring deployment plan based on the asset landscape, wherein:
the ring deployment plan comprises a plurality of deployment rings for incrementally deploying the new code; and
the plurality of target assets are assigned to a deployment ring of the plurality of deployment rings according to the asset landscape; and
initiate deployment of the new code to a first subset of the target assets assigned to a first deployment ring of the plurality of deployment rings.

2. The computing apparatus of claim 1, wherein the processor-executable instructions to determine the asset landscape of the plurality of target assets, when executed by the processor, further direct the computing apparatus to:
determine a plurality of asset properties for the plurality of target assets;
group the plurality of target assets into a plurality of asset groups, wherein the target assets in an asset group share at least one common asset property; and
determine the asset landscape based on a distribution of the plurality of target assets into the plurality of asset groups.

3. The computing apparatus of claim 1, wherein:
the processor-executable instructions to determine the asset landscape of the plurality of target assets, when executed by the processor, further direct the computing apparatus to:
group the plurality of target assets into a plurality of asset groups; and
determine the asset landscape based on a distribution of the plurality of target assets into the plurality of asset groups;
the processor-executable instructions to generate the ring deployment plan based on the asset landscape, when executed by the processor, further direct the computing apparatus to:
determine a number of rings for the ring deployment plan;
determine a diversity of coverage for target asset assignment to a respective deployment ring of the plurality of deployment rings; and
compute a minimum number of target assets from an asset group of the plurality of asset groups for assignment to the first deployment ring, wherein the minimum number of target assets from a respective asset group:
satisfies the diversity of coverage; and
comprises the first subset of target assets assigned to the first deployment ring.

4. The computing apparatus of claim 1, wherein:
the processor-executable instructions to generate the ring deployment plan based on the asset landscape, when executed by the processor, further direct the computing apparatus to:
determine a minimum number of target assets for assignment to a respective deployment ring of the plurality of deployment rings;
generate a listing of target assets assigned to the respective deployment ring of the plurality of deployment rings; and
add asset information to a respective target asset in the listing of target assets; and
the processor-executable instructions to initiate deployment of the new code to the first subset of the target assets assigned to the first deployment ring of the plurality of deployment rings, when executed by the processor, further direct the computing apparatus to:
transmit the ring deployment plan comprising the listing of target assets to an deployment system for execution.

5. The computing apparatus of claim 1, wherein the processor-executable instructions, when executed by the processor, further direct the computing apparatus to:
detect an issue with the new code responsive to deployment of the first deployment ring;
determine that the issue corresponds to a portion of target assets within the first subset of target assets comprising a common asset property; and
update the ring deployment plan based on the issue affecting the portion of target assets.

6. The computing apparatus of claim 1, wherein the processor-executable instructions to determine the asset landscape of the plurality of target assets, when executed by the processor, further direct the computing apparatus to:
determine a plurality of asset properties for the plurality of target assets, wherein an asset property comprises at least one of:
a device category;
an exposure score;
an operating system platform; or
remote service capabilities;
group the plurality of target assets into a plurality of asset groups; and
determine the asset landscape based on a distribution of the plurality of target assets into the plurality of asset groups.

7. A method comprising:
determining, by a ring orchestration engine, a plurality of target assets within a scope of deployment of a new code;
determining, by the ring orchestration engine, one or more asset properties for the plurality of target assets;
generating, by the ring orchestration engine, the plurality of target assets into a plurality of asset groups based on the one or more asset properties;
determining, by the ring orchestration engine, an asset landscape for the plurality of target assets based on the plurality of asset groups;
generating, by the ring orchestration engine, a ring deployment plan based on the asset landscape; and
initiating deployment, by the ring orchestration engine, of the new code according to the ring deployment plan.

8. The method of claim 7, wherein:
the method further comprises detecting, by the ring orchestration engine, initiation of a deployment process for the new code; and
determining, by the ring orchestration engine, the one or more asset properties for the plurality of target assets further comprises:
collecting, by the ring orchestration engine, asset information of the plurality of target assets; and
identifying, by the ring orchestration engine, the one or more asset properties for the plurality of target assets from the asset information.

9. The method of claim 7, wherein determining, by the ring orchestration engine, the plurality of target assets within the scope of deployment of the new code further comprises:
analyzing, by the ring orchestration engine, the new code to determine one or more code properties of the new code;
determining, by the ring orchestration engine, the scope of the deployment of the new code based on the one or more code properties;
determining, by the ring orchestration engine, a plurality of computing devices available for deployment of the new code; and
filtering, by the ring orchestration engine, the plurality of computing devices to identify the plurality of target assets based on the scope of the deployment of the new code.

10. The method of claim 7, wherein generating, by the ring orchestration engine, the ring deployment plan based on the asset landscape further comprises:
conducting, by the ring orchestration engine, a randomized statistical sampling of an asset group of the plurality of asset groups, wherein the randomized statistical sampling is based on a distribution of the plurality of target assets across the plurality of asset groups; and
identifying, by the ring orchestration engine, a first subset of target assets for a first deployment ring based on the randomized statistical sampling of the plurality of asset groups.

11. The method of claim 7, wherein the ring deployment plan comprises a plurality of deployment rings for incrementally deploying the new code, and the method further comprises:
determining, by the ring orchestration engine, a minimum number of target assets for assignment to a deployment ring of the plurality of deployment rings;
determining, by the ring orchestration engine, a diversity of coverage for target asset assignment based on the asset landscape; and
assigning, by the ring orchestration engine, the plurality of target assets to a deployment ring of the plurality of deployment rings based on the minimum number of target assets and the diversity of coverage.

12. The method of claim 7, wherein:
the method further comprises:
generating, by the ring orchestration engine, a recommendation that the new code be deployed according to the ring deployment plan; and
causing, by the ring orchestration engine, a client device to display the recommendation; and
initiating deployment, by the ring orchestration engine, of the new code according to the ring deployment plan further comprises:
receiving, from the client device, an indication to deploy the new code according to the ring deployment plan; and
transmitting, by the ring orchestration engine, ring information for at least a first deployment ring of the ring deployment plan to deployment system for execution.

13. The method of claim 7, wherein generating, by the ring orchestration engine, the ring deployment plan based on the asset landscape further comprises:
determining, by the ring orchestration engine, a number of rings for the ring deployment plan;
determining, by the ring orchestration engine, a plurality of deployment rings based on the number of rings and the asset landscape, wherein the plurality of deployment rings incrementally deploy the new code to a subset of the plurality of target assets; and
assigning, by the ring orchestration engine, at least one target asset from an asset group of the plurality of asset groups to a deployment ring of the plurality of deployment rings based on the asset landscape.

14. The method of claim 7, wherein the method further comprises:
responsive to deployment of the ring deployment plan, detecting, by the ring orchestration engine, an issue with the new code;
determining, by the ring orchestration engine, that the issue corresponds to a subgroup of target assets within the first deployment ring comprising a common target property; and
updating, by the ring orchestration engine, the ring deployment plan by removing the portion of target assets from at least a second deployment ring based on the issue affecting the portion of target assets.

15. A computer readable storage media comprising processor-executable instructions configured to cause a processor to:
determine, by a ring orchestration engine, a plurality of target assets for deployment of a new code;
determine, by the ring orchestration engine, an asset landscape for the plurality of target assets;
generate, by the ring orchestration engine, a ring deployment plan based on the asset landscape, wherein:
the ring deployment plan comprises a plurality of deployment rings for incrementally deploying the new code; and
the plurality of target assets are assigned to a deployment ring of the plurality of deployment rings according to the asset landscape; and
transmit, by the ring orchestration engine, ring information for a first deployment ring of the plurality of deployment rings to a deployment system for execution, wherein the deployment system deploys the new code to a first subset of the target assets assigned to the first deployment ring responsive to receiving the ring information.

16. The computer readable storage media of claim 15, wherein:
the processor-executable instructions to determine, by the ring orchestration engine, the asset landscape for the plurality of target assets cause the processor to further execute processor-executable instructions stored in the computer readable storage media to:
determine, by the ring orchestration engine, a plurality of asset properties for the plurality of target assets; and
group, by the ring orchestration engine, the plurality of target assets into a plurality of asset groups, wherein the target assets in an asset group share at least one common asset property; and
the processor-executable instructions to generate, by the ring orchestration engine, the ring deployment plan based on the asset landscape cause the processor to further execute processor-executable instructions stored in the computer readable storage media to:
assign, by the ring orchestration engine, at least one target asset from an asset group of the plurality of asset groups to a deployment ring of the plurality of deployment rings based on the asset landscape.

17. The computer readable storage media of claim 15, wherein the processor-executable instructions cause the processor to further execute processor-executable instructions stored in the computer readable storage media to:
responsive to deployment of the first deployment ring, detect, by the ring orchestration engine, an issue with the new code;
determine, by the ring orchestration engine, that the issue corresponds to a subgroup of target assets within the first subset of target assets comprising a common target property; and
update, by the ring orchestration engine, the ring deployment plan by removing the portion of target assets from at least a second deployment ring based on the issue affecting the portion of target assets.

18. The computer readable storage media of claim 15, wherein the processor-executable instructions to determine, by the ring orchestration engine, the plurality of target assets cause the processor to further execute processor-executable instructions stored in the computer readable storage media to:
analyze, by the ring orchestration engine, the new code to determine one or more code properties of the new code;
determining, by the ring orchestration engine, a plurality of computing devices available for deployment of the new code; and
filtering, by the ring orchestration engine, the plurality of computing devices to identify the plurality of target assets based on the one or more code properties of the new code.

19. The computer readable storage media of claim 15, wherein:
the processor-executable instructions to determine, by the ring orchestration engine, the asset landscape for the plurality of target assets cause the processor to further execute processor-executable instructions stored in the computer readable storage media to:
group, by the ring orchestration engine, the plurality of target assets into a plurality of asset groups, wherein the target assets in an asset group share at least one common asset property; and
the processor-executable instructions to generate, by the ring orchestration engine, the ring deployment plan based on the asset landscape cause the processor to further execute processor-executable instructions stored in the computer readable storage media to:
conduct, by the ring orchestration engine, a randomized statistical sampling of an asset group of the plurality of asset groups, wherein the randomized statistical sampling is based on a distribution of the plurality of target assets across the plurality of asset groups; and
assign, by the ring orchestration engine, at least one target asset from an asset group of the plurality of asset groups to a respective deployment ring of the plurality of deployment rings based on the randomized statistical sampling of the plurality of asset groups.

20. The computer readable storage media of claim 15, wherein:
the processor-executable instructions cause the processor to further execute processor-executable instructions stored in the computer readable storage media to:
generate, by the ring orchestration engine, a recommendation that the new code be deployed according to the ring deployment plan; and
cause, by the ring orchestration engine, a client device to display the recommendation; and
the processor-executable instructions to transmit, by the ring orchestration engine, the ring information for the first deployment ring of the plurality of deployment rings to the deployment system for execution cause the processor to further execute processor-executable instructions stored in the computer readable storage media to:
receive, from the client device, an indication to deploy the new code according to the ring deployment plan; and
transmit, by the ring orchestration engine, the ring information for the first deployment ring to deployment system responsive to the indication.
